(19) United States
(12) Patent Application Publication
(10) Pub. No.: US 2005/0083194 A1
(43) Pub. Date: Apr. 21, 2005

(54) Wireless vital signs transmission device in a physiological detector

(76) Inventor: Yuan-Yao Shen, Taipei (TW)

Correspondence Address: APEX JURIS, PLLC, 13194 EDGEWATER LANE NORTHEAST, SEATTLE, WA, 98125, US

(21) Appl. No.: 10/690,087

(22) Filed: Oct. 20, 2003

(51) Int. Cl. G08B 1/08

(52) U.S. Cl. 340/539.12; 340/573.1

(57) ABSTRACT

Disclosed herein is a wireless vital signs transmission system which can transmit with various wireless modes, a variety of human vital signal monitored by proper detecting devices, to desired terminal electronic devices, or even transfer to further remote destination for displaying on, storing in, or cautioning by the electronic devices, after the vital signs have been processed by a processor built in the transmission system.

### BACKGROUND OF THE INVENTION

1. Field of the Invention

Present invention relates to a wireless vital signs transmission device,connecting with a detector used in monitoring various vital finctions, including a body surface sensor, in vivo sensor or in vivo biochip detector.

2. Description of the Prior Art

Amazing advance of high-tech engineering has accelerated biochip utilization technology and human physiological condition detection technique. Various human physiological conditions can be monitored with proper detecting devices including different types of biochips through skin contact or implantation under the skin so as to promptly obtain state of vital signs or symptoms of illness.

In addition to aforesaid progress of biochip technology, the microelectronic device as well as the nanometer technology has also fantastically advanced to reach the extent as being able to catch the data signals about the human body via the biochips attached on or implanted under the skin or even swallowed into the gastrointestinal.

It has already been comprehensively practicable to monitor the human physiological data such as temperature, blood pressure, pulse rate . . . etc. from the body surface, also there are many portable physiological data sensor available on the market. How it is a fantastic dream to offer a cellular phone the function able to immediately process these data obtained from the above mentioned sensor and transmit the treated results to display on, store in, or caution by a desired terminal electronic device or even further transfer to another remote destinations.

In order to realize the aforementioned dream to offer the cellular phone a mission to serve as one of the proficient medical instruments, the inventor has endeavored for years by continuous research and experimentation attempting to find out a way to supplement the current insufficient function of the cellular phone, and at last has come out with the present invention.

### SUMMARY OF THE INVENTION

Accordingly, it is an object of the present invention to provide a wireless vital signs transmission device which can transmit, through a wireless way, Uarious human vital signs monitored by proper detecting devices, and after being processed, to desired terminal electronic devices so as to display, store, caution, or even further transfer to another remote destination.

It is another object of the present invention to provide a wireless vital signs transmission system which can receive signals form various vital signs detection devices monitored from the human body, the devices including swallowed or implanted or skin contacted biochips.

It is one more object of the present invention to provide a wireless vital signs transmission device which can transmit the vital signs of the human body to desired terminal electronic devices by the infrared ray mode, the blue tooth mode, or 820,11b mode.

To achieve these and other objects mentioned above, the device of the present invention includes:

A signal receiving module receives the human vital signs from various detecting devices including a skin surface contacting biochip, an implanted biochip, or the like.

A signal conversion module converts the human vital signs inputted to the signal receiving module into programmable data information and outputs the same to a microprocessor.

The microprocessor analyses, compares, and store said data information inputted from the signal conversion module, and outputs the resultant data to a signal transmission module.

The signal transmission module transmits the resultant data to various desired terminal electronic devices by way of wireless transmission modes for displaying on, storing in, cautioning, or even transferring the resultant data to further remote destinations.

### BRIEF DESCRIPTION OF THE DRAWINGS

The above objects and other advantages of the present invention will become more lucid by describing in detail the preferred embodiments of the present invention with reference to the attached drawings in which:

FIG. 1 is a block diagram illustrating the operational flow of the present invention;

FIG. 2 is a perspective operational view in an embodiment of the present invention; and

FIG. 3 is a perspective operational view in another embodiment of the present invention.

### DETAILED DESCRIPTION OF THE PREFERRED EMBODIMENT

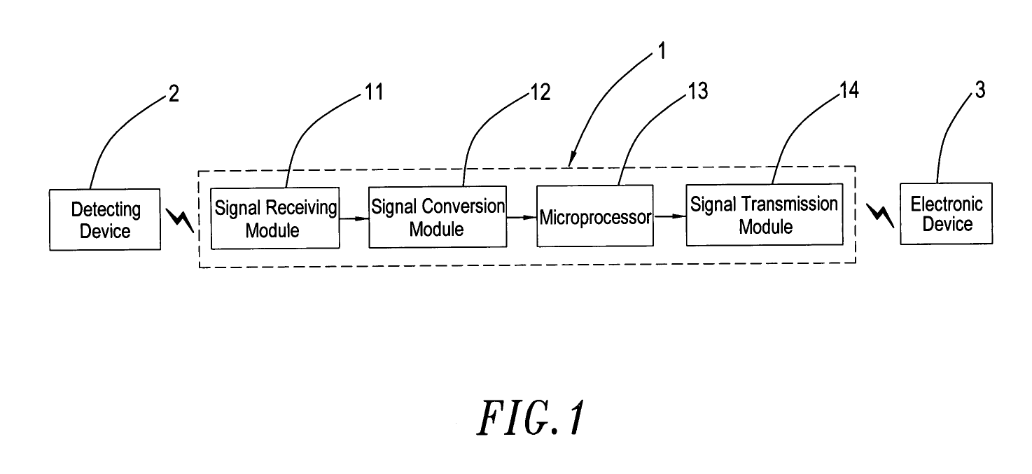

Referring to FIG. 1, it is a block diagram illustrating the operational flow of the present invention. It is seen from FIG. 1, the wireless vital signs transmission device 1 essentially comprises:
a signal receiving module 11 for receiving various human vital signs reported from various detecting devices 2 including a swallow-in biochip, an implanted biochip, a skin surface contacting biochip, or the like;
a signal conversion module 12 for converting the human vital signs inputted to the signal receiving module 11 into programmable data information and outputting the same to a microprocessor 12;
the microprocessor 13 for analyzing, comparing, and storing said data information inputted from the signal conversion module 12, and outputting the resultant data to a signal transmission module 14; and
the signal transmission module 14 for transmitting said resultant data to an external desired terminal electronic device 3 by way of wireless transmission modes such as, infrared ray, blue teeth, or 820,11b for displaying, storing, cautioning, or even further transferring to another remote destination.

Incidentally, the wireless vital signs transmission device 1 may be microminiaturized into a system-on-a-chip(SOC) so as to facilitate fabrication and utilization.

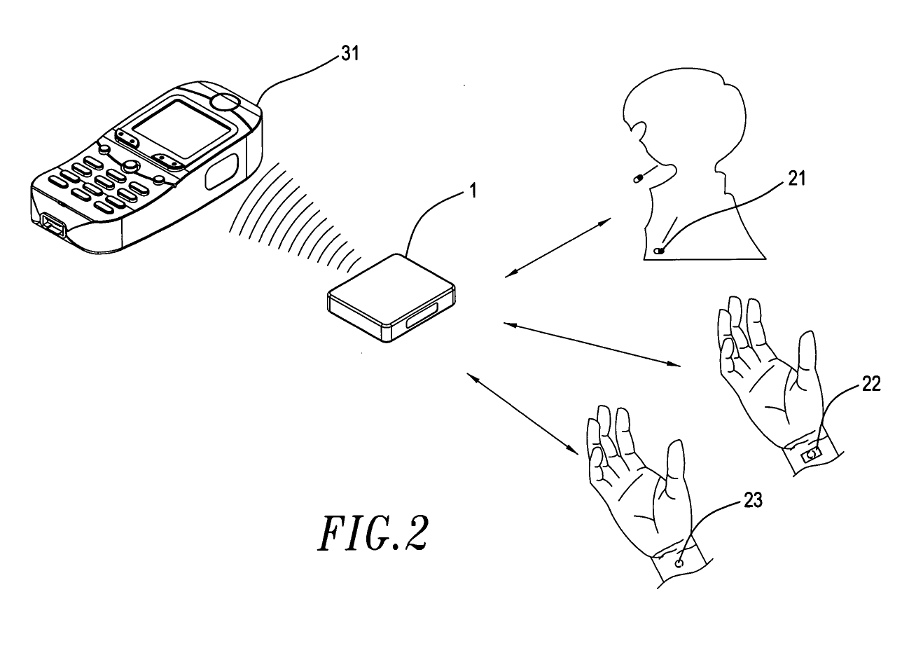

Referring to FIG. 2, in this embodiment of the present invention, the human vital signs such as temperature, pulse rate, blood pressure, blood glucose and the like reported to the system 1 from a swallow-in biochip 21, an implanted biochip 22, and a skin contacting biochip 23 are processed, compared, and identified in said system 1, and afterwards the resultant data information is inputted into a cellular phone 31 by way of wireless transmission mode so as to display on, store in, or caution by the cellular phone 31, or even transfer from there to a further remote destination.

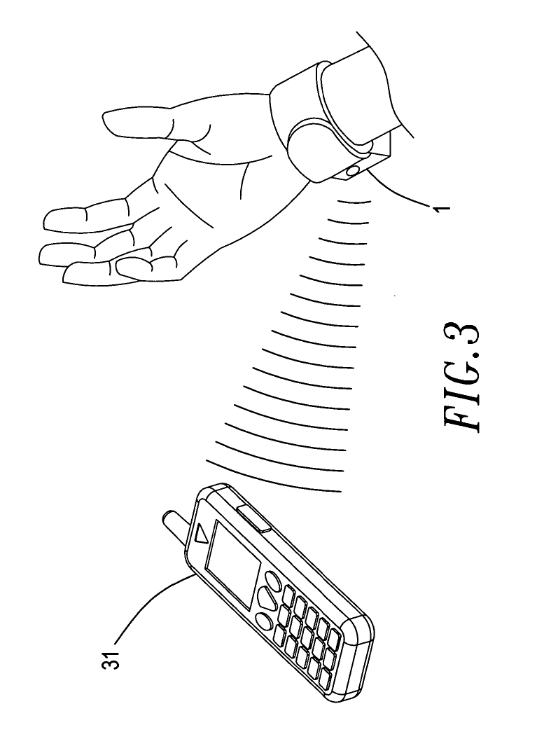

Referring to FIG. 3, in the second embodiment of the present invention, the wireless vital signs transmission device 1 is formed into a wrist watch type device of good portability to directly receive various human vital signs reported from the aforementioned biochips affixed to the human body by way of wireless modes. Similar to the first embodiment, this data information is displayed on, store in, or cautioned by the cellular phone 31, or even transferred from there to a further remote destination.

It emerges from the above description that the system of the present invention is well established to have several noteworthy advantages namely:

1.The human vital signs can be detected by the system of the present invention widely includes temperature, pulse rate, blood pressure, respiratory quotient, blood glucose and the like and after being processed, are transmitted to desired terminal electronic devices for displaying on, storing in, or cautioning by the same, or even transferring the information to a further remote destination so as to ensure the user's health.

2.A variety of biochips such as a swallow-in type, an implanting type, and an skin contact type are all well applicable to the system of the present invention so that the utilization field of the biochip is widened.

3.The wireless transmission modes usablein the present invention includes infrared ray, blue teeth or 820,11b resulting in raising the value of these conventional transmission means.

Although the description above contains many specificities, these should not be construed as limiting the scope of the invention but as merely providing illustration of some of the presently preferred embodiments of this invention. Thus the scope of the invention should be determined by the appended claims and their legal equivalents, rather than by the examples given.

1. A wireless vital sings transmission device in a set of physiological detector essentially comprising:
a set of signal receiving module for receiving the human vital signs from various detecting devices;
a signal conversion module for converting said human vital signs imputed to said signal receiving module into programmable data information and outputting the same to a microprocessor;
said microprocessor for analyzing, comparing, and storing said data information inputted from said signal conversion module, and outputting resultant data to a signal transmission module, and
said signal transmission module for transmitting said resultant data to various desired terminal electronic devices by way of wireless transmission modes for displaying on, storing in, cautioning, or even transferring said resultant data to further remote destinations.

2. The system as in claim 1, wherein said detecting device including; sensors of various types, a swallow-in biochip, an implanted biochip, and a skin contact biochip.

3. The system as in claim 1, wherein said wireless transmission modes including infrared ray, blue teeth, and 820,11b transmissions.

4. The system as in claim 1, wherein said transmission system is microminiaturized into a system-on-a-chip(SOC) so as to facilitated fabrication and utilization.

5. The system as in claim 1, wherein said electronic devices including a cellular phone, a notebook computer, a personal digital assistance, or the like which are operable for displaying, cautioning, or further transferring said data information.
